(19) United States
(12) Patent Application Publication
(10) Pub. No.: US 2012/0183023 A1
(43) Pub. Date: Jul. 19, 2012

(54) IMPLEMENTATIONS FOR WIRELESS SIGNAL PROCESSING

(75) Inventors: Daniel F. Filipovic, Solana Beach, CA (US); Jifeng Geng, San Diego, CA (US)

(73) Assignee: QUALCOMM Incorporated, San Diego, CA (US)

(21) Appl. No.: 13/006,818

(22) Filed: Jan. 14, 2011

(51) Int. Cl. H04B 1/38

(52) U.S. Cl. 375/220

(57) ABSTRACT

Implementations including methods, apparatuses, and systems relating to processing wireless signals are disclosed. Such processing may be performed, at least in part, at a receiver platform receiving such wireless signals and/or at a remote computing platform to obtain information that may be used in a variety of contexts, including cellular communications, radio-frequency identification, and navigation. In some techniques, modulated signals are received at a receiver platform, and at least partially demodulated and used to generate data. The data is transmitted to one or more network resources, and processed to obtain information based on the information in the modulated signals.

### BACKGROUND

1. Field

The subject matter disclosed herein relates to electronic devices, and more particularly to methods, apparatuses, and systems for use in and/or with electronic devices for wireless signal processing.

2. Information

Wireless signals may be used, for example, to transmit information between a wireless transmitter and a wireless receiver. Such wireless signals may be modulated according to one or more predetermined modulation format such as those utilized, for example, by satellite positioning systems (SPS), cellular communication systems, and/or radio-frequency identification (RFID) systems. Wireless signals received by a wireless receiver may be processed, for example, by demodulating received wireless signals to obtain a variety of information. Such information may include positioning information in the context of SPS, voice and/or other data in the context of cellular communications systems, or an identifier that may be used to retrieve information at a database in the context of RFID systems.

### SUMMARY

Implementations relating to processing wireless signals are disclosed. In one implementation, a method is provided that comprises receiving one or more wireless signals modulated according to one or more predetermined modulation formats, and optionally processing the received one or more wireless signals to obtain raw in-phase and quadrature (I/Q) data. The method may further comprise transmitting one or more signals representative of the raw I/Q data to a remote server via a communication network for further processing. This summary provides an example implementation not limiting claimed subject matter.

### BRIEF DESCRIPTION OF DRAWINGS

FIG. 1 is a schematic block diagram of an example network environment according to one implementation.

FIG. 2 is a schematic diagram of an example receiver according to one implementation.

FIG. 3 is a flow diagram depicting an example process for processing one or more signals according to one implementation.

FIG. 4 is a flow diagram depicting an example process for processing raw I/Q data obtained from one or more wireless signals modulated at least in part according to one or more satellite positioning system modulation formats according to one implementation.

FIG. 5 is a diagram depicting a three-dimensional search domain according to one implementation.

FIG. 6 is a flow diagram depicting an example process for obtaining a list of energy peaks detected in a search region according to one implementation.

FIG. 7 is an energy plot showing a peak as may be obtained from a received wireless signal according to one implementation.

### DETAILED DESCRIPTION

Implementations including methods, apparatuses, and systems relating to processing wireless signals are disclosed. Such signal processing may be performed, at least in part, at a receiver platform or receiving unit (e.g., a mobile device or wireless access point) for receiving wireless signals and/or further signal processing may be further performed, at least in part, at a remote computing platform (e.g., a remote server) to obtain information that may be used in a variety of contexts, including cellular communications, radio-frequency identification, and navigation to name a few examples. Distributed signal processing across two or more networked platforms may provide increased processing capability and/or may enable a reduction in a processing requirement or a processing burden of a receiver platform. Such a reduction in a processing requirement or a processing burden may enable a reduction in cost, complexity, size, and/or weight of a receiver platform in at least some implementations by utilization of a remote computing platform to provide at least some signal processing of wireless signals received by the receiver platform.

Implementations including methods, apparatuses, and systems relating to processing wireless signals that are modulated, at least in part, according to one or more satellite positioning system (SPS) modulation formats are also disclosed. In such implementations, positioning information may be obtained based, at least in part, on a plurality of correlations using an evaluation of hypotheses spanning at least two dimensions or at least three dimensions. In a context of SPS, such hypotheses may span one or more of a codephase dimension, a Doppler dimension, and/or a carrier frequency drift dimension. In at least one implementation, evaluation of hypotheses spanning two or more dimensions may be performed, at least in part, at a remote computing platform to enable a reduction in a signal processing requirement or a processing burden of a receiving platform.

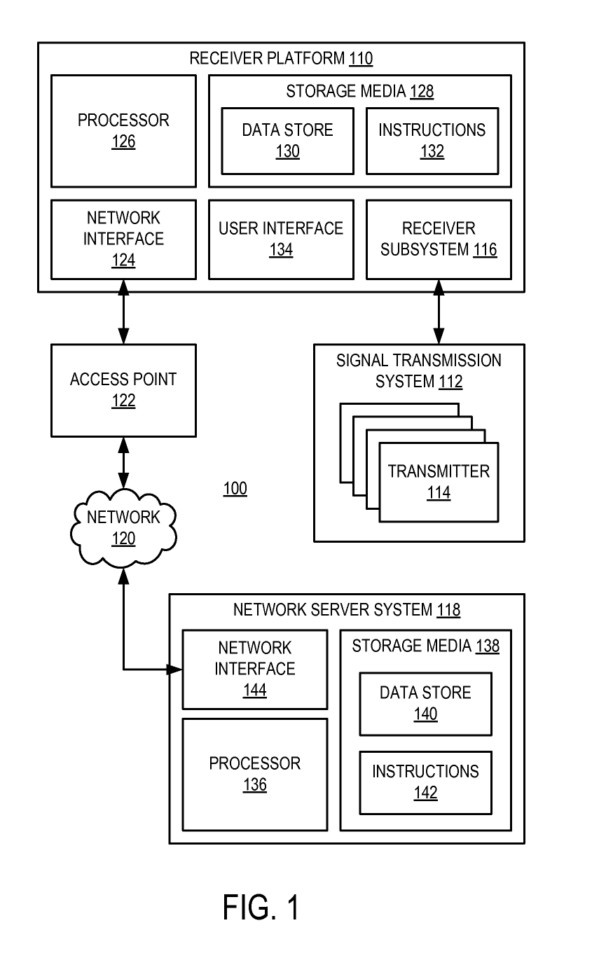

FIG. 1 is a schematic block diagram of an example network environment 100 according to one implementation. In the example implementation of FIG. 1, network environment 100 includes a receiver platform 110 that may receive wireless signals from a signal transmission system 112. In at least one implementation, receiver platform 110 may comprise a mobile device or a wireless access point that may receive wireless signals from signal transmission system 112.

Signal transmission system 112 may comprise one or more wireless transmitters such as example wireless transmitter 114 to transmit wireless signals modulated according to one or more predetermined modulation formats. Receiver platform 110 may comprise a receiver subsystem 116 to receive one or more wireless signals from one or more wireless transmitters such as wireless transmitter 114 of signal transmission system 112. In at least one implementation, receiver subsystem 116 may include a wireless receiver to receive wireless signals.

In at least one implementation, receiver subsystem 116 may further include a local oscillator; for example, as a component of an electronic circuit. The local oscillator may be a crystal oscillator comprising piezoelectric material that provides mechanical resonance of a vibrating crystal to create an electrical signal. An electrical signal produced by the local oscillator may comprise an oscillating signal of one or more frequencies that may be used by other signal processing components. An oscillating signal produced by a local oscillator may be used by signal processing components, for example, to provide a clock signal that may be used to obtain codephase and pseudorange measurements of received SPS signals, demodulate a received wireless signal from radio frequency to baseband frequency, and/or perform other processes.

In at least one implementation signal transmission system 112 may comprise a satellite positioning system (SPS) to transmit wireless signals to receiver platform 110 that are at least in part modulated according to a SPS format. A SPS may include, for example, the Global Positioning System (GPS) and/or other like Global Navigation Satellite System (GNSS) such as Galileo or GLONASS, a regional satellite system, or some combination. As one example, wireless transmitter 114 may reside at an orbiting space vehicle (SV) or may reside at a terrestrial location in the case of a ground based pseudolite. A pseudolite may comprise a ground-based transmitter that may broadcast a PN code or other ranging code (e.g., similar to a GPS or CDMA cellular signal) modulated on an L-band (or other frequency) carrier signal, which may be synchronized with GPS time, for example. Such a transmitter may be assigned a distinguishable PN code so as to permit identification by a remote receiver such as receiver platform 110. Accordingly, receiver subsystem 116 may comprise an SPS receiver in at least one implementation to receive wireless signals that are modulated according a SPS modulation format. The above described SPS modulation formats are merely examples that are provided according to a particular implementation.

In at least one implementation, signal transmission system 112 may comprise a radio-frequency identification (RFID) system to transmit wireless signals to receiver platform 110 that are at least in part modulated according to an RFID format. As one example, signal transmission system 112 may comprise a component of an RFID tag and receiver platform 110 may comprise an RFID reader. As another example, signal transmission system 112 may comprise a component of an RFID reader and receiver platform 110 may comprise an RFID tag. In such implementations, receiver subsystem 116 may comprise an RFID receiver to receive one or more wireless signals that are at least in part modulated according to an RFID modulation format.

In at least one implementation, signal transmission system 112 may comprise a system to transmit wireless signals to receiver platform 110 that are at least in part modulated according to a wireless communication protocol format including, for example, a cellular communication protocol format, a personal area network (PAN) format (e.g., Bluetooth, infrared data association (IrDA), a wireless personal area network (WPAN) format, etc.), a wireless local area network (WLAN) format (e.g., Wi-Fi, WiMAX, etc.), a wide area network format (e.g., the Internet protocol suite (TCP/IP)), or other suitable communication protocol or combinations thereof. A cellular communication protocol may include, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), a Long Term Evolution (LTE) protocol, among other cellular communication protocols. In cellular communication implementations, for example, receiver subsystem 116 may comprise a wireless cellular receiver to receive one or more wireless signals that are at least in part modulated according to a wireless cellular communication protocol.

Network environment 100 may further comprise a network server system 118 in at least one implementation. Network server system 118 may comprise one or more servers with which receiver platform 110 may communicate via a communication network 120. Communication network 120 may be implemented as one or more of a wide area network (WAN) (e.g., the Internet), a local area network (LAN) (e.g., an intranet), and/or a personal area network (PAN) to name a few examples. In at least one implementation, receiver platform 110 may communicate with communication network 120 by transmitting wireless signals to and/or receiving wireless signals from an access point 122. In wireless communication implementations, access point 122 may comprise a wireless receiver and/or a wireless transmitter to communicate with network interface 124 of receiver platform 110. Access point 122 may comprise a base station or wireless hot spot, for example. Access point 122 and communication network 120 may collectively support any suitable communication protocol or combination of communication protocols to facilitate wired or wireless communication between receiver platform 110 and network server system 118. For example, access point 122 and communication network 120 may support the Internet protocol suite (TCP/IP), WiFi protocol, WiMAX protocol, cellular communication protocol (e.g., GSM, CDMA, etc.), etc., among others. Network interface 124 of receiver platform 110 may receive signals via wired or wireless communication from and/or transmit signals via wired or wireless communication to access point 122 to communicate with network server system 118. Accordingly, network interface 124 in wireless communication implementations may comprise a wireless receiver to receive wireless signals from access point 122 and/or a wireless transmitter to transmit wireless signals to access point 122.

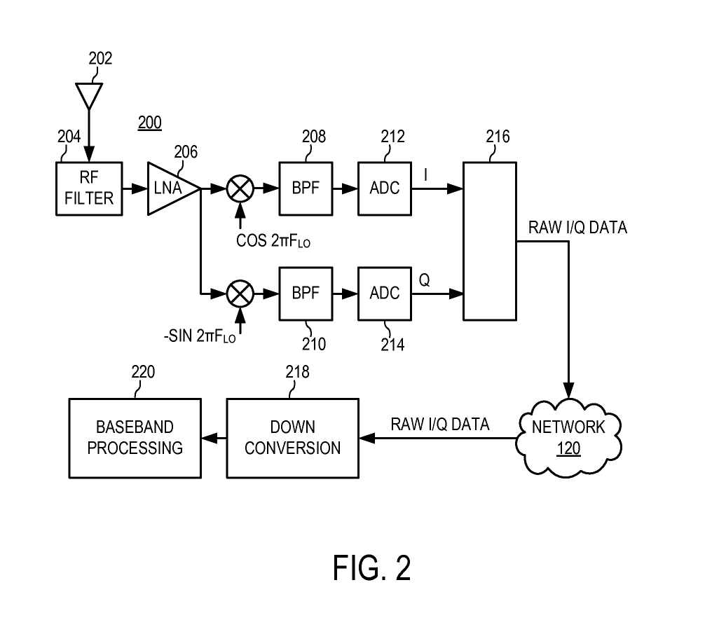

Receiver platform 110 may include one or more processors such as example processor 126 to execute instructions (e.g., software, firmware, executable code, etc.). Receiver platform 110 may include storage media 128. Storage media 128 may include a data store 130 and/or instructions 132 stored thereon that are executable by one or more processors such as example processor 126 to perform one or more of the methods, processes, operations, or functions disclosed herein, for example, with reference to the flow diagrams of FIGS. 2, 3, 4 and 6. “Storage media” herein does not refer to transitory propagated signals.

A human user (i.e., a user) may interact with receiver platform 110 in some implementations via a user interface 134 comprising one or more input devices and/or output devices. For example, receiver platform 110 may include an input device comprising one or more of a keyboard, a pointing device such as a mouse or a controller, a touch-sensitive graphical display (e.g., a touch screen), a microphone, or other suitable device for receiving user input. Receiver platform 110 may include an output device comprising one or more of a graphical display, audio speaker, haptic feedback device, or other suitable device for outputting (e.g., presenting) information to a user.

Receiver platform 110 in mobile device implementations may comprise a mobile computing platform such as a cellular phone, a smart phone, an RFID device, a personal digital assistant, a low duty cycle communication device, a laptop computer, a personal or vehicular based navigation unit, and/or the like or combinations thereof. As another example implementation, receiver platform 110 may take the form of one or more integrated circuits, circuit boards, and/or the like that may be operatively enabled for use in another device. Network server system 118 may comprise one or more computing platforms comprising one or more processors such as example processor 136, storage media 138 having a data store 140 and/or instructions 142 stored thereon that are executable by one or more processors, and a network interface 144 for communicating with receiver platform 110 via communication network 120.

Wireless signals received at receiver platform 110 from signal transmission system 112 may be processed in a number of ways. As a non-limiting example, instructions 132, upon execution by one or more processors such as example processor 126 may enable receiver platform 110 to receive via receiver subsystem 116, one or more wireless signals modulated according to one or more predetermined modulation formats and obtain raw in-phase and quadrature (I/Q) data from the received one or more wireless signals.

FIG. 2 is a schematic diagram of an example receiver 200 for according to one implementation. Referring also to FIG. 2, wireless signals received at a receiver platform (e.g., receiver platform 110) may be processed, at least in part, by mixing the received wireless signals with a local oscillator (LO) signal having a frequency F_{LO} that is determined based, at least in part, on a carrier frequency f1 about which a spectrum of a received wireless signal is centered. As shown in FIG. 2, the outputs of the mixers are in-phase and quadrature signals. The local oscillator signal may be produced, for example, by a crystal oscillator. In at least one implementation, a frequency F_{LO} may be selected such that when the LO signal is mixed with the received signal a desired portion of the signal will be within a range of a bandpass filter, such as filters 208, 210.

As shown in FIG. 2 according to a particular implementation, a receiver 200 which may perform at least a portion of the signal processing performed, for example, by receiver subsystem 116 and/or processor 126 of receiver platform 110. Wireless signals may be received at a radio frequency (RF) antenna 202. A bandpass RF filter such as surface acoustic wave (SAW) filter 204 and low-noise amplifier 206 may be applied to the received signals in some implementations. The received signals may then be downconverted to intermediate frequencies by mixing the received signals with the LO signal as shown.

In this context, a “downconversion” may relate to transforming an input signal having a first frequency characteristic to an output signal having second frequency characteristic. In one particular implementation, although claimed subject matter is not limited in this respect, such a downconversion may comprise transformation of a first signal to a second signal, where the second signal has a frequency characteristic of a lower frequency than that of the first signal. Here, in particular examples, such a downconversion may comprise transformation of a radio frequency (RF) signal to an intermediate frequency (IF) signal, or transformation of an IF signal to a baseband signal and/or baseband information. However, these are merely examples of a downconversion and claimed subject matter is not limited in this respect.

In-phase and quadrature (I/Q) components filtered by associated BPFs 208 and 210 may then be digitally sampled at analog to digital conversion circuits (ADCs) 212 and 214 to provide digitally sampled in-phase and quadrature components for further processing as illustrated below. “Raw I/Q data” herein refers to the digitally sampled in-phase and quadrature components of the downconverted signal. ADCs 212 and 214 may be adapted to sample output signals of BPFs 208 and 210 at suitable sampling rates, for example. It should be understood, however, that other architectures may be implemented without deviating from claimed subject matter. In other implementations, for example, analog to digital conversion may occur following a second downconversion (not shown). Again, these are merely example implementations and claimed subject matter is not limited in these respects. Also, in alternative implementations, ADCs 212 and 214 may be replaced with a single complex ADC or with a single time shared and/or multiplexed ADC with appropriate delays to be shared between in-phase and quadrature signal paths.

According to particular implementations, sampled I/Q components (raw I/Q data) provided by ADCs 212 and 214 may be packetized, compressed, and/or processed in any suitable manner at processor 216 for transmission to a remote computing platform for further processing of the raw I/Q data. Such processing of the raw I/Q data for transmission to a remote computing platform may comprise reformatting the raw I/Q data according to any suitable communication protocol supported by a communication network (e.g., in IP packets) linking a receiver platform and a remote computing platform. In such implementations, raw I/Q data transmitted through network 120 may be further processed at a remote computing platform such as previously described network server system 118, for example. Raw I/Q data that is received at the remote computing platform via a communication network may be further processed, for example, to provide downconversion 218 prior to baseband processing at 220 (e.g., if the raw I/Q data is modulated onto a carrier for transmission). Accordingly, processing of raw I/Q data included in wireless signals received at a receiver platform may be performed at least partially at a remote computing platform in at least some implementations. Here, it should be understood that the particular receiver 200 shown in FIG. 2 is merely an example implementation and that claimed subject matter is not limited in this respect.

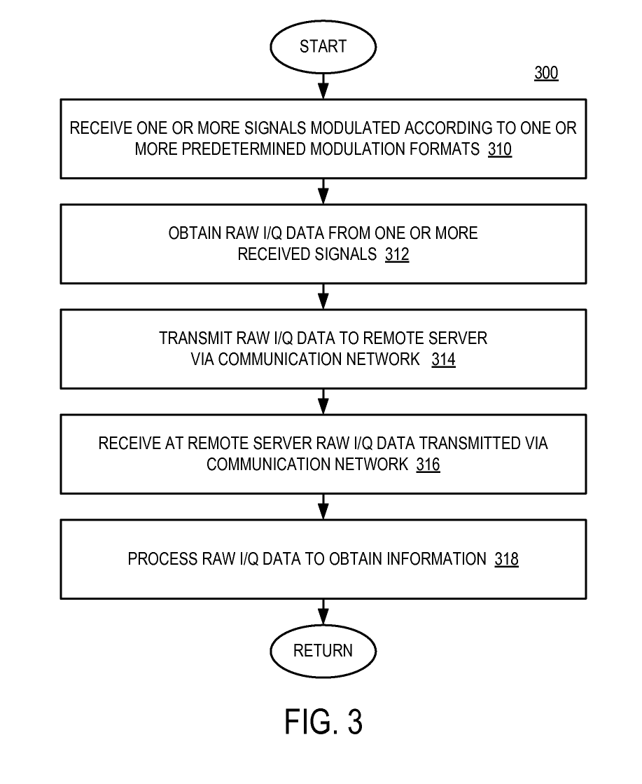

FIG. 3 is a flow diagram depicting an example process 300 for processing one or more wireless signals received at a receiver platform according to one implementation. Process 300 may be performed, at least in part, by previously described receiver platform 110 and/or network server system 118 in the context of network environment 100 of FIG. 1. For example, a remote server of network server system 118 may be utilized to provide at least partial demodulation of modulated wireless signals.

At 310, one or more wireless signals may be received at a wireless receiver (e.g., of a receiver platform such as platform 110 of FIG. 1). The one or more received wireless signals may be modulated according to one or more predetermined modulation formats as discussed above. In particular, the wireless signals may be satellite signals, cellular signals, RFID signals, or other wireless signals.

At 312, raw in-phase/quadrature (I/Q) data may be obtained at a receiver platform from one or more wireless signals received at a wireless receiver of the receiver platform. As previously described with reference to FIG. 2, a receiver platform receiving wireless signals from a signal transmission system may process the received wireless signals to obtain raw I/Q data.

At 314, raw I/Q data obtained from one or more wireless signals may be transmitted from a receiving platform receiving such wireless signals (e.g., a mobile device or wireless access point) to a remote server via a communication network. Raw I/Q data may be transmitted, for example, as one or more signals representative of the raw I/Q data. Such raw I/Q data may be transmitted in a compressed or uncompressed state, packetized, modulated onto a carrier, etc. In the context of a mobile computing platform, raw I/Q data may be transmitted by a receiver platform (e.g., receiver platform 110 of FIG. 1) as one or more wireless signals that are directed to a remote server (e.g., network server system 118 of FIG. 1) that may be received via a wireless transmission at a base station, WiFi access point, or other type of access point (e.g., access point 122 of FIG. 1). At 316, raw I/Q data transmitted via a communication network as signal information (e.g., originating from a receiver platform) may be received at a remote server. In implementations where at least some raw I/Q data is instead processed on-board a receiver platform, such raw I/Q data may or may not be transmitted to a remote server. Hence, at least operations 314 and 316 may be omitted in such implementations.

At 318, raw I/Q data may be processed using one or more network resources to obtain information from the raw I/Q data. The raw I/Q data may be obtained from the received signals, and may be stored at a network server. For example, raw I/Q data may be processed at a remote server in some implementations or at a receiver platform in other implementations to obtain information from the raw I/Q data. In implementations where one or more received wireless signals are at least in part modulated according to an RFID modulation format, information obtained by processing the raw I/Q data at operation 318 may comprise an identifier included in the wireless signal (originally received at a receiver such as receiver platform 110 of FIG. 1). At a network resource, the identifier information is used to obtain associated information from a database. As one example, a database may reside at a network resource such as a data store of a computing platform such as a remote server or a receiver platform.

In implementations where one or more received wireless signals are at least in part modulated according to a wireless cellular communication protocol, information obtained by processing raw I/Q data at operation 318 may comprise voice data, video data, and/or other kinds of data that may be transmitted using cellular communication protocols. For example, a remote server or a receiver platform may produce information that comprises voice data obtained from raw I/Q data.

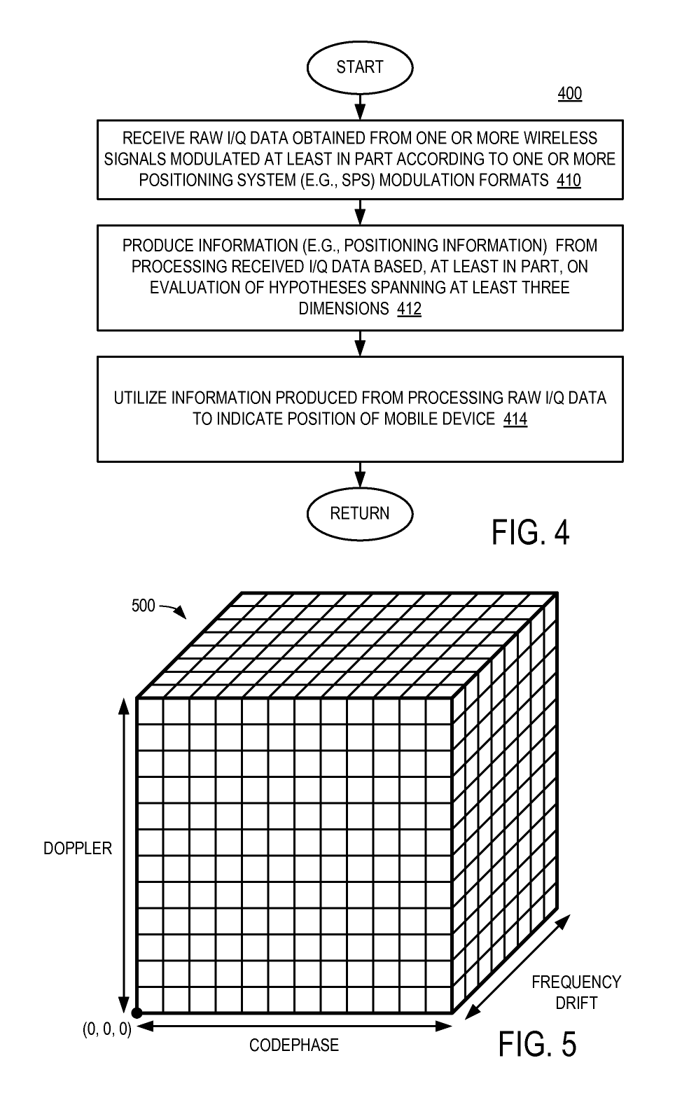

In implementations where one or more received wireless signals are modulated at least in part according to one or more SPS modulation formats, information obtained by processing raw I/Q data at operation 318 may comprise determining positioning information. For example, a remote server may process raw I/Q data to perform correlation operations and/or may process raw I/Q data to determine one or more bits of a navigation message (generally a message transmitted by navigation satellites that includes satellite orbit information such as almanac information and ephemeris information, time information such as a Time Of Week (TOW), satellite health information, etc.) FIG. 4 describes in further detail, an example process 400 for processing raw I/Q data obtained from one or more received wireless signals that are modulated at least in part according to one or more SPS modulation formats.

Information obtained from processing raw I/Q data may be transmitted from a remote server to a receiver platform or other suitable networked computing platform via a communication network, for example, in implementations where processing of the raw I/Q data is performed, at least in part, by the remote server. For example, information obtained from the raw I/Q data may be transmitted via a communication network as one or more signals representative of such information. Such information obtained from processing raw I/Q data may be received from a remote server at a receiver platform (e.g., the receiver platform that initially received one or more wireless signals at operation 310) via a communication network. However, in some implementations, processing of raw I/Q data may be instead performed at least partially on-board a receiver platform, for example, without requiring transmission of raw I/Q data to a remote computing resource for processing.

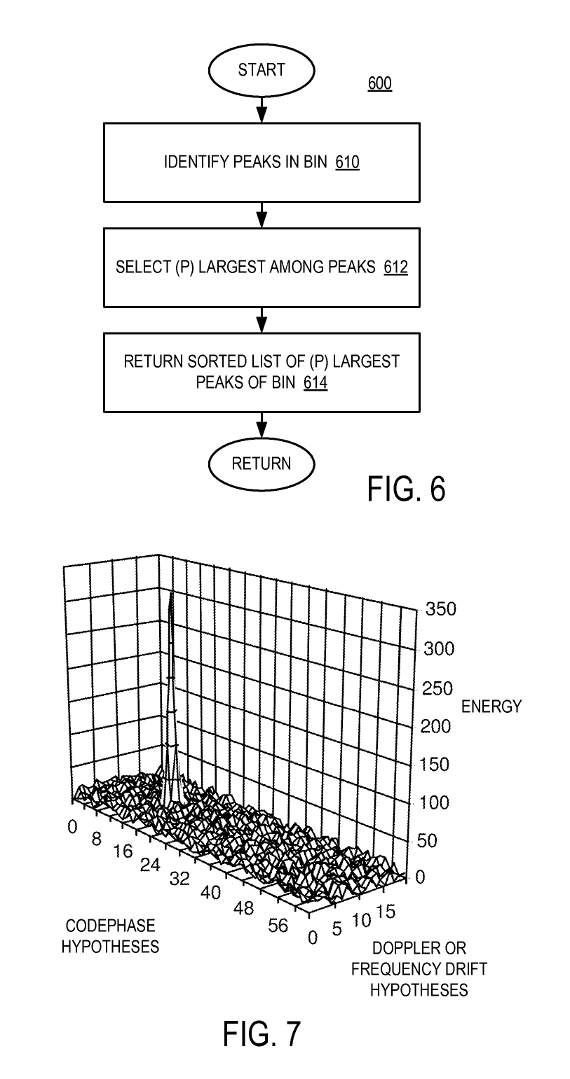

FIG. 4 shows a process 400 for processing raw I/Q data obtained from one or more wireless signals modulated according to a satellite positioning system (SPS) modulation format according to one implementation. Here, raw I/Q data may be processed to estimate an offset in a time domain indicated by a codephase between a code of a received wireless signal and a reference code. Correlation peak detection may be applied to a received wireless signal for measuring codephase. Codephase in this context may indicate a time delay between transmission by a satellite and reception of a signal at a receiver platform resulting from propagation of that signal at finite speed (e.g., speed of light). Codephase may thereby provide an indication of a distance between a transmitter and receiver that is commonly referred to as a pseudorange. Pseudorange measurements obtained from a number of transmitters (e.g., four transmitters) may be used to estimate a position of a receiver platform through trilateration or pseudo-trilateration based approaches, for example. Raw I/Q data may also be processed to estimate a Doppler shift in a frequency of a received wireless signal relative to a reference frequency that may be caused by a combined movement of a transmitter relative to a receiver of the wireless signal. Identification of Doppler shift in received wireless signals may enable correction and alignment of detected energy peaks for the purpose of measuring codephase. Process 400 further describes how a received SPS signal may be processed to obtain codephase through correlation peak detection in a particular search domain by utilizing a hypothesis based approach. In at least one implementation, a plurality of correlation operations are performed to evaluate a number of hypotheses in one or more of a frequency drift dimension, codephase dimension, and/or Doppler dimension in piecewise steps. Such piecewise steps may be representative of discrete bins of a search domain. As one example, a search domain may comprise a range of codephase bins, Doppler bins, and/or frequency drift bins associated with respective codephase hypotheses, Doppler hypotheses, and/or frequency drift hypotheses. As one example, I/Q data representative of a satellite signal received at the receiver platform may be correlated with a generated PN code at different codephase offsets and codephase may be detected based upon the location of an energy peak detected within a codephase search window as will be discussed in more detail with reference to FIGS. 6 and 7.

At 410, raw I/Q data that is obtained at a receiver platform from one or more wireless signals modulated at least in part according to one or more SPS modulation formats may be received. In one implementation, raw I/Q data may be received from a receiver platform at a remote server via a communication network as discussed above. In another implementation, at least some raw I/Q data obtained from one or more wireless signals received at a receiver platform may be instead processed at the receiver platform without necessarily involving transmission of raw I/Q data to a remote server. SPS signals received at a wireless receiver may be encoded with a repeating sequential code in at least some implementations. For example, a satellite in the Global Positioning System (GPS) will transmit its coarse acquisition pseudorandom noise (PN) code and its navigation message modulated onto the L1 carrier (1575.42 MHz).

At block 412, positioning information may be obtained from processing received I/Q data based, at least in part, on a plurality of correlations using hypotheses spanning a number of dimensions. In at least one implementation, positioning information may be produced based, at least in part, on an evaluation of hypotheses spanning at least two dimensions including at least a codephase dimension and a Doppler dimension. In another implementation, positioning information may be produced based, at least in part, on an evaluation of hypotheses spanning at least three dimensions including at least a codephase dimension, a Doppler dimension, and a carrier frequency drift dimension. In yet another implementation, positioning information may be produced based, at least in part, on an evaluation of hypotheses spanning at least two dimensions or at least three dimensions including at least a frequency drift dimension and may further include one or more of a codephase dimension, a Doppler dimension, and/or other suitable dimension.

As noted above, it may be desirable to consider relative motion between a receiver (e.g., of a receiver platform) and a transmitter (e.g., of a signal transmission system). Here, such relative motion between a receiver and a transmission source may cause a Doppler shift in a frequency of the wireless signal received at a receiver. For a terrestrial GPS based client (e.g., receiver platform) in a particular implementation, a Doppler shift due to combined movement of the SV and client relative to one another may amount to an error of approximately +/−2.7 ppm, for example. Frequency error of one or more oscillators at the receiver may add approximately another 2 ppm, for a total of 4.7 ppm of frequency uncertainty (alternatively, local oscillator error may be corrected at least somewhat, e.g. with a PLL or other correction loop). This 4.7 ppm corresponds to about +/−7.5 kHz at the L1 carrier frequency of 1.57542 GHz.

Accordingly, in addition to a codephase dimension, a Doppler dimension may also be established for detection of energy peaks. Many techniques and corresponding correlator and searcher structures may be used to detect energy peaks in two-dimensions or three-dimensions, or any number of dimensions using operations in a time domain and/or a frequency domain. In one particular example, correlation peaks may be evaluated in a time (e.g., codephase) domain for particular codephase hypotheses. Such an operation may be repeated across a desired range of codephase hypotheses. For example, in order to determine the pseudorange between the receiver platform and a particular satellite, a number of versions of the satellite's PN code at different code phase offsets may be generated and correlated with the raw I/Q data representative of the satellite signals received at the receiver platform. The determined peak of the correlation may then be used to determine the measured pseudorange for that satellite. In some implementations, many correlations may be performed in parallel, to reduce the time to determine the pseudorange(s).

Evaluating correlation peaks in other dimensions such as a carrier frequency drift dimension (e.g., in addition to codephase and Doppler dimensions) may also be performed. One issue related to carrier frequency drift arises from physical properties of a crystal oscillator of a wireless receiver that varies with temperature or other parameter. As one example, a temperature transient (e.g., a temperature increase or decrease) at a crystal oscillator may result in a drift in the oscillator frequency. An oscillator of a wireless receiver may experience a temperature increase caused, for example, by prolonged use and/or increased intensity of use of the wireless receiver, which may in turn result in movement of energy peaks in a search domain. As a non-limiting example, for a receiver platform to obtain a position fix in a weak signal area (e.g., to facilitate a 911 emergency geo-location reporting operation to an operator) a wireless receiver of the receiver platform may operate at higher or maximum power settings which may cause a rapid temperature increase, potentially resulting in a frequency drift of the crystal oscillator. Such movement may be more tolerable with relatively shorter correlations (e.g., one or two milliseconds). However, in at least some implementations, to obtain suitable correlations, a length of time of such correlations may be increased (e.g., to 1.0 second or more) to obtain a signal that is distinguishable from background noise. Accordingly, a hypothesis based approach may be utilized whereby many (e.g., tens, hundreds, thousands, etc.) frequency drifts may be hypothesized across one or more other dimensions (e.g., codephase dimensions, Doppler shift dimensions, etc.) to identify energy peaks representative of a correlation between a code of a received signal and a reference signal.

At 414, positioning information obtained from processing raw I/Q data may be utilized to indicate position of a receiver platform such as the receiver platform that received the one or more wireless signals from which the raw I/Q data was obtained. In implementations where processing of raw I/Q data is performed, at least in part, at a remote server, such positioning information may be transmitted from the remote server to a receiver platform from which the raw I/Q data originated or other suitable computing platform that may otherwise utilize such positioning information. In other implementations, positioning information may be obtained at the receiver platform from processing at least some of the raw I/Q data locally without necessarily requiring communication with a remote server. A mobile device, wireless access point, or other suitable receiver platform that receives or obtains such positioning information may utilize the positioning information to provide or otherwise obtain an estimate of a position of the receiver platform. Positioning information may also be used to provide an indication of orientation, velocity, acceleration, or other state information for the receiver platform.

Hence, in at least one implementation, a remote server may correlate raw I/Q data with pseudo-noise code sequences and perform codephase peak detection. For example, a remote server may represent detected correlation peaks in a multiple-dimension array representing codephase detection hypotheses. Codephase may be used as an indication of a delay of a received wireless signal, which in turn may be used to indicate a measure of a distance between a transmitter of the wireless signal and a receiver of the wireless signal. Additionally or alternatively, codephase may be used in synchronizing operations relating to the reception and/or transmission of one or more other wireless signals. For example, timing information derived from codephase may be used to synchronize a receiver to a slotted access channel. In at least one implementation, an array may be used to identify correlation peaks by codephase and Doppler dimensions, for example. In other implementations, an array may be used to identify correlation peaks in a three-dimensional array by codephase, Doppler, and carrier frequency drift. For example, multiple incremental frequency drifts may form a third dimension (e.g., as piecewise linear frequency drifts) with at least two other dimensions comprising codephase and Doppler parameters. Introduction of a third dimension for frequency drift may enable relaxing requirements for receiver front-end oscillator accuracy/stability at a receiver platform and/or enable use of less expensive front-end oscillators at a receiver platform.

FIG. 5 is a diagram depicting a three-dimensional search domain 500 (e.g., a three-dimensional grid) according to one implementation. Search domain 500 is depicted in this example as extending across a number of hypotheses (e.g., bins) in each of codephase, Doppler, and frequency drift dimensions. In at least one implementation, a search may be conducted (for example, according to a search window of (D) Doppler hypotheses by (C) codephase hypotheses by (F) frequency drift hypotheses to obtain a grid of (D)×(C)×(F) energy results. As a non-limiting example, a three-dimensional search domain may extent across tens, hundreds, or thousands of bins in a Doppler dimension; tens, hundreds, or thousands of bins in a codephase dimension; and two or more bins (e.g., tens, hundreds, or thousands or bins) in a frequency drift dimension. However, in some implementations, a two-dimensional search domain may extend across a plurality of hypotheses (e.g., bins) in only a select two of codephase, Doppler, and/or frequency drift dimensions. Such a grid may enable hypotheses to be evaluated in one or more of the codephase, Doppler, and/or frequency drift dimensions in piecewise steps.

In at least one implementation, a search domain may be referenced to a target frequency (e.g., predetermined modulation format) of a received wireless signals. In a context of GPS, for example, a search domain may be referenced to the GPS frequency 1575.42 MHz, whereby the search domain may be defined relative to that frequency. For example, a corner of a three-dimensional grid may be defined as having zero error in each of the three-dimensions at position (0, 0, 0) of the grid for the target frequency. Errors in any of the three-dimensions may correspond to an energy peak observed in a bin of the grid at a position that is spaced apart from the zero error position in a dimension corresponding to the dimension in which the error is present.

Selection of a particular location and/or spacing of hypotheses (e.g., bins) of each dimension of a search domain may be guided by other information, for example, obtained externally and/or from one or more previous searches. For example, it may be known or estimated that a desired signal lies within a certain number of chips from a given codephase, and/or that a signal may be found within a certain bandwidth around a given frequency, such that a search domain may be defined accordingly. In at least one implementation, supplemental information for improving search processes may be transmitted and/or received with raw I/Q data (e.g., as metadata). Such supplemental information may indicate any suitable information to facilitate and/or improve searching of a search domain, for example, by limiting a number or range of hypotheses utilized for a given search.

For example, supplemental information may comprise one or more of a crystal oscillator identifier which may be used by a computing platform to obtain information from a database indicating physical properties of a crystal (e.g., temperature dynamics), an indication of temperature at or near the crystal oscillator or receiver platform, an indication of a change of temperature at or near the crystal oscillator or receiver platform, and/or an indication of operating parameters of the crystal oscillator or receiver platform, such as, for example, power consumption, duty cycle, etc. As one example, supplemental information may indicate or may be used by a computing platform to obtain an indication of non-linear frequency drift behavior attributed to temperature transients. Accordingly, recognition of non-linear frequency drift by a searcher may enable non-linear progression of hypotheses that are utilized during a given search.

Spacings and ranges of hypotheses in one or more of the disclosed dimensions may be varied based on factors such as strength of the desired signal, interfering signal strength, range of codephase and frequency uncertainty, desired accuracy, desired probability of detection, and desired time-to-fix. For example, in the context of GPS, a codephase spacing may include 1 chip, ½ chip, and ¼ chip. Frequency ranges include, for example, +/−31.25 Hz, 62.5 Hz, 125 Hz, and 250 Hz, with the range being divided into, for a particular implementation, twenty frequency bins.

FIG. 6 is a flow diagram depicting an example process 600 for providing a list of energy peaks detected in a search region according to one implementation. In at least one implementation, process 600 may be performed at a remote server such as at network server system 118 in the context of network environment 100 of FIG. 1. In another implementation, process 600 may be performed at a receiver platform such as receiver platform 110.

Process 600 may be performed in some implementations for individual bins of a domain. A domain may comprise a multi-dimensional search domain (e.g., two-dimensional, three-dimensional, or larger number of dimensions), such as search domain 500 of FIG. 5, for example. A search domain comprising a number of bins may be reduced in at least one implementation to perform process 600 to select bins of the domain, for example, on the basis of additional information. Accordingly, process 600 may be performed for each of (d) bins in a domain having a bin size (D), where (d) is greater than one and less than or equal to bin size (D) of the domain.

Although as a matter of convenience this description refers to the notion of a grid of energy values, it should be understood that it may not be necessary for all of the values in such a grid to exist at any one moment. While some values are being processed, other values of the “grid” may not yet have been calculated, while values of the “grid” that have already been processed may have been replaced. Indeed, even within a bin it may not be necessary for all of the values to exist at any one moment, and processing of a bin according to some implementations of process 600 may begin before all bin values are available.

At 610, energy peaks in a bin may be identified. For example, operation 610 may be implemented to classify as peaks those energy results which are local maxima in one or more of a codephase space, a Doppler space, and/or a frequency drift space. For example, local maxima may be identified for two or three of a codephase space, a Doppler space, and/or a frequency drift space. In at least one implementation, operation 610 may skip the first and/or last codephase hypotheses for each bin, as sufficient information to determine whether the results at these points are local maxima may not be available. However, it may be desired to perform operation 610 such that results at grid points which are excluded from process 600 are still considered in determining whether a result under test is a local maximum. In some implementations of operation 610, computational complexity may be reduced by skipping (in codephase and/or in Doppler phase, and/or frequency drift phase) grid points that are adjacent to identified local maxima in either dimension.

At 612, a (P) largest among the peaks in a bin may be selected. The value of (P) may be selected, for example, according to a desired maximum allowed number of multipaths (N). The value of (N), which may be selected heuristically, may be chosen from among a set of values according to a characteristic of the received signal and/or the receiving environment. The presence of separable multipaths has been found, in at least some examples, to occur mostly at very low signal-to-noise ratios, with the highest number of multipaths occurring in an urban canyon environment. In one example, the value of (N) may be set to four. It may be desirable to set the value of (P) to at least (N+1). In one implementation, different numbers of peaks may be selected from different bins, e.g. based on past search results. For example, values of parameters (P) and/or (N) may vary from bin to bin. One or more bins may be excluded from process 600 by selecting zero peaks for such bins in operation 612. Operations 610 and 612 may be performed serially and/or in parallel.

At 614, a sorted list may be returned of the (P) largest peaks of a bin. For example, operation 614 may sort each peak list and forward the sorted peak lists to another operation for further processing. In one example, process 600 may be performed by a first array of logic elements (e.g. an embedded processor) according to executable instructions (e.g., a firmware program), and operation 614 may pass the sorted bin lists to a second array of logic elements (e.g. a microprocessor) for further processing according to executable instructions (e.g., a software program). Sorting of the bin peak lists may already be accomplished with the completion of operation 612, as a peak list may be sorted as each peak is selected. A set of (d) lists of peaks may be created by implementation of process 600. Each list may correspond to one of bins 0 to (d−1), and each list entry may indicate an energy result and may be associated with a particular hypothesis or set of hypotheses in any number of dimensions. Each list may be sorted by energy in increasing or decreasing order of magnitude, for example.

FIG. 7 shows an example of a peak within an energy grid of twenty bins of a first dimension (e.g., a Doppler dimension or a frequency drift dimension), each bin having 64 codephase hypotheses of a codephase dimension. In this example, adjacent codephase hypotheses are ½-chip apart, such that the grid extends across 32 chips in code space. An energy peak in this figure may indicate presence of a selected satellite vehicle (SV) signal at codephase hypothesis 16 in Doppler or frequency drift bin 10, for example. A searcher (e.g., a searching module or engine) implemented by a processor of a receiver platform or remote server may produce energy grids for several different corresponding SVs from the same portion of a received wireless signal, with the grids possibly having different dimensions.

In an example situation, a peak having the highest energy within a grid may correspond to a valid correlation, so that locating a code among various hypotheses may comprise finding a peak with the highest energy. However, in multipath examples, the highest peak within a grid may not necessarily correspond to the most accurate correlation. Therefore, it may be desirable to conduct additional processing of at least some of the grid values to locate the received code. In one particular example, a location of the largest peak in a grid may be associated with a location of the valid correlation result. However, if a relatively strong peak is found in the same Doppler bin and/or frequency drift bin as the largest peak, and within eight chips before it, for example, then the earlier peak may be assumed to be the first (i.e. most direct) multipath of the same signal and is selected as the valid correlation result instead.

For received wireless signals having relatively low energy levels (such as GPS signals), it may be desirable to accumulate energy at a particular grid point using coherent integration. In the time domain, coherent integration may be accomplished by summing correlation and/or energy results over more than one consecutive code period of the received code, and in the Doppler domain it may be performed by summing each of the frequency components over time, for example. Because a GPS C/A signal is modulated with data at a rate of 50 bits/second, coherent integration of the signal may be limited to twenty milliseconds. If the data is known a priori, it may be removed from the signal (a process called data wipeoff or modulation wipeoff), and the coherent integration period may be extended to 40 milliseconds or even up to 160 milliseconds or more, for example. Non-coherent integration may also be applied to combine results from non-consecutive code periods, or coherent integration periods, up to 88 or more times. In a receiver platform having an integrated GPS receiving device, the integration time may be limited by a maximum tune-away time relating to requirements of the communications channel.

A correlation relationship of an input signal A(t) and a given hypothesized signal B(t) may be identified, for example, where the given hypothesized signal B(t) may be a function of two-dimensions or three-dimensions. A particular hypothesized signal B(t) may be identified as sufficient when it exhibits a correlation relationship with A(t) that exceeds a predetermined threshold as indicated, for example, by the largest peaks of one or more peak lists.

A correlation of a received code sequence with a reference code may be performed in a time domain by integrating the product of the received and reference codes over some portion of the length of the reference code according to relation (1) as follows:

$$y ( t ) = {\int }_{k = 0}^{N - 1} x ( t + k ) r ( k ) \qquad ( 1 )$$

where x is the received code, r is the reference code of length N, and y(t) is the correlation result at offset t. Here, a received code may comprise a complex baseband signal, such that the correlation is performed for each of I and Q components of the received code.

Alternatively, a correlation result of the received signal and reference code for a given offset may be obtained by convolving the signal with, for example, a matched filter of the complex reference code r+jr (i.e. a filter having an impulse response that is the time-reversed complex conjugate of the reference code) according to relation (2) as follows:

$$y ( t ) = {\int }_{k = 0}^{N - 1} r * ( N - 1 - k ) x ( t - k ) \qquad ( 2 )$$

where r*=r−jr is the complex conjugate of the complex reference code.

For a GPS C/A code implementation, the results of relations (1) and (2) over a range of offsets will have the shape of a sinc function, just as an example. While correlation results obtained using either expression (and/or another expression of the degree of correlation of the two codes) may be used as an energy result for the corresponding offset, the energy result may be calculated as the sum of the squares of such correlation results for the I and Q components. The result of such a calculation over a range of offsets may have the shape of a (sinc)² function, whose peak is sharper and thus more localized than that of a sinc function.

In a particular implementation, the received code x is determined, at least in part, at a downconversion (e.g., downconversion 218) in which local oscillators are combined (e.g., mixed) with received I and Q components. To form hypotheses in a frequency drift dimension as a third dimension (e.g., with code phase and Doppler being first and second dimensions), local oscillators at different frequencies may be mixed with received I and Q components to provide corresponding different resulting received codes x. The different resulting received codes x may then be processed according to relations (1) and/or (2) to generate hypotheses in a third, frequency drift, dimension.

The wireless receivers described herein may be enabled for use in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor. In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the above description, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features. In the preceding detailed description, numerous specific details have been set forth to provide a thorough understanding of claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

1. A method, comprising:
at a mobile device, receiving one or more wireless signals modulated according to one or more predetermined modulation formats;
obtaining raw in-phase and quadrature (I/Q) data from the received one or more wireless signals; and
transmitting one or more signals representative of the raw I/Q data from the mobile device to a remote server via a communication network.

2. The method of claim 1, and further comprising:
receiving from the remote server via the communication network one or more signals representative of information obtained from processing the signals representative of the raw I/Q data.

3. The method of claim 2, wherein the received one or more wireless signals are at least in part modulated according to a radio-frequency identification (RFID) modulation format, and wherein the information obtained from at least a partial processing of the signals representative of the raw I/Q data comprises information retrieved from a database associated with an identifier determined from the signals representative of the raw I/Q data.

4. The method of claim 2, wherein the received one or more wireless signals are at least in part modulated according to a wireless cellular communication protocol, and wherein the information obtained from processing the signals representative of the raw I/Q data comprises voice data.

5. The method of claim 2, wherein the received one or more wireless signals are modulated at least in part according to one or more satellite positioning system (SPS) modulation formats, and wherein the information obtained from processing the signals representative of the raw I/Q data comprises positioning information.

6. The method of claim 5, wherein the information obtained from processing the signals representative of the raw I/Q data is produced based, at least in part, on an evaluation of a plurality of correlations using hypotheses spanning at least two dimensions including at least a codephase dimension and a Doppler dimension.

7. The method of claim 5, wherein the information obtained from processing the signals representative of the raw I/Q data is produced based, at least in part, on an evaluation of a plurality of correlations using hypotheses spanning at least three dimensions including at least a codephase dimension, a Doppler dimension and a frequency drift dimension.

8. The method of claim 7, wherein the hypotheses are evaluated in the frequency drift dimension in piecewise steps.

9. A method, comprising:
receiving via a communication network raw I/Q data obtained from one or more wireless signals modulated according to one or more predetermined modulation formats; and
obtaining information from processing the received raw I/Q data based, at least in part, on a plurality of correlations using an evaluation of hypotheses spanning at least three dimensions, the three dimensions including at least a codephase dimension, a Doppler dimension, and a frequency drift dimension.

10. The method of claim 9, wherein receiving raw I/Q data comprises receiving the raw I/Q data at a remote server as signal information originating from a receiver platform.

11. The method of claim 9, further comprising:
transmitting a signal representative of the obtained information from the remote server to the receiver platform via the communication network.

12. The method of claim 9, wherein the one or more predetermined modulation formats comprises one or more satellite positioning system (SPS) modulation formats, and wherein the information comprises positioning information determined at the remote server from the raw I/Q data.

13. A mobile device, comprising:
a receiver to receive wireless signals;
a network interface to communicate with a communication network;
a processor to:
receive via the receiver one or more wireless signals modulated according to one or more predetermined modulation formats;
obtain raw I/Q data from the received one or more wireless signals; and
initiate transmission, via the network interface, of one or more signals representative of the raw I/Q data to a remote server via the communication network.

14. The mobile device of claim 13, wherein the receiver comprises an RFID receiver to receive the one or more wireless signals that are at least in part modulated according to an RFID modulation format; and
wherein the processor is further to receive via the network interface information that comprises information retrieved from a database associated with an identifier obtained from the raw I/Q data.

15. The mobile device of claim 13, wherein the receiver comprises a wireless cellular receiver to receive the one or more wireless signals that are at least in part modulated according to a wireless cellular communication protocol; and
wherein the processor is further to receive via the network interface information that comprises voice data obtained from the raw I/Q data.

16. The mobile device of claim 13, wherein the receiver comprises a satellite positioning system (SPS) receiver to receive the one or more wireless signals that are modulated at least in part according to one or more satellite positioning system (SPS) modulation formats; and
wherein the processor is further to receive via the network interface information that comprises positioning information obtained from the raw I/Q data.

17. The mobile device of claim 16, wherein the processor is further to receive the information that is obtained from the raw I/Q data based, at least in part, on a plurality of correlations using an evaluation of hypotheses spanning at least two dimensions including at least a codephase dimension and a Doppler dimension.

18. The mobile device of claim 16, wherein the processor is further to receive the information that is produced based, at least in part, on a plurality of correlations using an evaluation of hypotheses spanning at least three dimensions including at least a codephase dimension, a Doppler dimension and a frequency drift dimension.

19. The mobile device of claim 13, wherein said processor is further to receive via the network interface from the remote server via the communication network one or more signals representative of information obtained from processing the raw I/Q data.

20. An apparatus, comprising:
a server system, comprising:
one or more computing platforms programmed with instructions to:
obtain via a communication network, one or more signals representative of raw I/Q data obtained at a mobile device from one or more wireless signals modulated according to one or more predetermined modulation formats;
obtain information from processing the raw I/Q data; and
transmit to the mobile device via the communication network, one or more signals representative of the information obtained from the processing of the raw I/Q data.

21. The apparatus of claim 20, wherein the one or more wireless signals are at least in part modulated according to an RFID modulation format; and
wherein the computing platform is further programmed with instructions to retrieve the information from a database associated with an identifier obtained from the raw I/Q data.

22. The apparatus of claim 20, wherein the one or more wireless signals are at least in part modulated according to a wireless cellular communication protocol; and
wherein the computing platform is further programmed with instructions to produce the information that comprises voice data.

23. The apparatus of claim 20, wherein the one or more wireless signals are at least in part modulated according to one or more satellite positioning system (SPS) modulation formats; and
wherein the computing platform is further programmed with instructions to produce the information that comprises positioning information obtained from the raw I/Q data.

24. The apparatus of claim 23, wherein the computing platform is further programmed with instructions to produce the information based, at least in part, on a plurality of correlations using an evaluation of hypotheses spanning at least two dimensions including at least a codephase dimension and a Doppler dimension.

25. The apparatus of claim 23, wherein the computing platform is further programmed with instructions to produce the information based, at least in part, on a plurality of correlations using an evaluation of hypotheses spanning at least three dimensions including at least a codephase dimension, a Doppler dimension and a frequency drift dimension.

26. The apparatus of claim 25, wherein the hypotheses are evaluated in the frequency drift dimension in piecewise steps.

27. An article, comprising:
storage media having instructions stored thereon executable by one or more processors to:
obtain raw I/Q data from one or more wireless signals received at a mobile device, said wireless signals modulated according to one or more predetermined modulation formats; and
initiate transmission of one or more signals representative of the raw I/Q data to a remote server via a communication network.

28. The article of claim 27 wherein storage media further includes instructions to receive from the remote server via the communication network one or more signals representative of information obtained from processing the raw I/Q data.

29. The article of claim 28, wherein the one or more predetermined modulation formats comprises at least an RFID modulation format, and wherein the received information comprises information retrieved from a database associated with an identifier obtained from the raw I/Q data.

30. The article of claim 28, wherein the one or more predetermined modulation formats comprises at least a wireless cellular communication protocol, and wherein the received information comprises voice data obtained from the raw I/Q data.

31. The article of claim 28, wherein the one or more predetermined modulation formats comprises at least one or more satellite positioning system (SPS) modulation formats, and wherein the received information comprises positioning information obtained from the raw I/Q data.

32. A mobile device, comprising:
means for receiving one or more wireless signals modulated according to one or more predetermined modulation formats;
means for obtaining raw I/Q data from the received one or more wireless signals; and
means for transmitting one or more signals representative of the raw I/Q data to a remote server via a communication network.

33. The mobile device of claim 32, and further comprising:
means for receiving from the remote server via the communication network one or more signals representative of information obtained from processing the raw I/Q data.

34. The mobile device of claim 33, wherein the one or more predetermined modulation formats comprises at least one or more satellite positioning system (SPS) modulation formats, and wherein the received information comprises positioning information obtained from the raw I/Q data; and
wherein the received information is produced based, at least in part, on a plurality of correlations using an evaluation of hypotheses spanning at least three dimensions including at least a codephase dimension, a Doppler dimension and a frequency drift dimension.
